(19) United States
(12) Patent Application Publication
(10) Pub. No.: US 2004/0135527 A1
(43) Pub. Date: Jul. 15, 2004

(54) Control apparatus for hybrid vehicles

(75) Inventors: Yusuke Tatara, Tokyo (JP); Kazuhisa Yamamoto, Utsunomiya-shi (JP); Hirokatsu Amanuma, Utsunomiya-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: HONDA MOTOR CO., LTD.

(21) Appl. No.: 10/740,498

(22) Filed: Dec. 22, 2003

(30) Foreign Application Priority Data
Jan. 15, 2003 (JP) 2003-006846

(51) Int. Cl. H02P 5/00

(52) U.S. Cl. 318/139

(57) ABSTRACT

A road situation is estimated. If in a slipping state (a wheel slip flag F_SLIP=1) or if an output changing switch is turned on by the driver of a hybrid vehicle, a second motor is energized based on a 4WD-oriented rear motor drive power map to avoid the slip. At the same time, a first motor is driven to generate electric power based on a 4WD-mode front motor charging map, thereby energizing the second motor.

### BACKGROUND OF THE INVENTION

1. Field of the Invention

The present invention relates to a control apparatus for a hybrid vehicle having an engine for driving one of front and rear wheels, a first motor coupled to the engine for driving the one of front and rear wheels and generating electric power, a second motor for driving the other of front and rear wheels and generating electric power, and a battery for storing electric power which is generated by the first motor and the second motor and supplying electric power to the first motor and the second motor.

2. Description of the Related Art

In recent years, there have been developed hybrid vehicles having drive wheels drivable by a combination of an internal combustion engine and an electric motor. Generally, the hybrid vehicle operates selectively in a plurality of modes which include an engine propulsion mode in which the hybrid vehicle is propelled by the engine alone, a motor propulsion mode in which the hybrid vehicle is propelled by the motor alone, a motor-assisted propulsion mode in which the output power of the engine is assisted by the motor while the hybrid vehicle is being propelled by the engine, and a power-generating propulsion mode in which electric power is generated by the motor and supplied to charge a battery.

There has been developed a hybrid vehicle having an engine for driving front wheels, an alternator driven by the engine, a motor for driving rear wheels, and a control means for controlling the amount of electric power generated by the alternator so as to reduce the difference between the rotational speeds of the front and rear wheels for thereby propelling the hybrid vehicle stably in a four-wheel drive mode in which the hybrid vehicle is propelled by the engine and the motor (see Japanese laid-open patent publication No. 11-318001).

In another known type of hybrid vehicle, a torque-assisting electric motor is coupled to an engine, and the hybrid vehicle has a mode selector switch operable by a driver for changing motor output torque characteristics to allow the hybrid vehicle to run with an appropriate torque depending on the situation of the road on which the hybrid vehicle travels and the pattern in which the driver drives the hybrid vehicle (see Japanese laid-open patent publication No. 9-58295).

According to the hybrid vehicle disclosed in Japanese laid-open patent publication No. 11-318001, the motor for driving the rear wheels is not controlled based on the difference between the rotational speeds of the front and rear wheels, but the amount of electric power generated by the alternator is controlled to adjust the load imposed on the engine to reduce the difference between the rotational speeds of the front and rear wheels. Consequently, the disclosed hybrid vehicle is problematic in that no sufficient drive power can be obtained on a snowy road or the like whose coefficient of friction is small. Another disadvantage is that the fuel economy may become poor as the engine may possibly be operated unduly.

The hybrid vehicle disclosed in Japanese laid-open patent publication No. 9-58295 is not designed for operation in a 4WD mode. For driving the hybrid vehicle in the various modes, a sufficient amount of electric power is required to increase the output of the torque-assisting electric motor. However, the disclosed hybrid vehicle has no guarantee to provide such a sufficient amount of electric power, and hence can travel in limited situations.

### SUMMARY OF THE INVENTION

It is a general object of the present invention to provide a control apparatus for controlling a hybrid vehicle to run stably and producing electric power for obtaining an output required to cause the hybrid vehicle to run stably.

A major object of the present invention is to provide a control apparatus for controlling a hybrid vehicle to have good fuel economy.

Another object of the present invention is to provide a control apparatus for controlling a hybrid vehicle to run stably while the hybrid vehicle tends to slip.

Still another object of the present invention is to provide a control apparatus for allowing the driver of a hybrid vehicle to change the output of an electric motor on the hybrid vehicle based on the running state of the hybrid vehicle.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a drive system of a hybrid vehicle;

FIG. 2 is a block diagram of a control apparatus for the hybrid vehicle according to an embodiment of the present invention;

FIG. 3 is a flowchart of a control sequence in a 4WD control mode of the hybrid vehicle according to the embodiment of the present invention;

FIG. 4 is a flowchart of a road situation estimating process in the control sequence shown in FIG. 3;

FIG. 5 is a diagram showing a 4WD-oriented rear motor drive power map;

FIG. 6 is a diagram showing a fuel-economy-oriented rear motor drive power map;

FIG. 7 is a diagram showing a 4WD-mode front motor charging map; and

FIG. 8 is a diagram showing a normal-mode front motor charging map.

### DESCRIPTION OF THE PREFERRED EMBODIMENTS

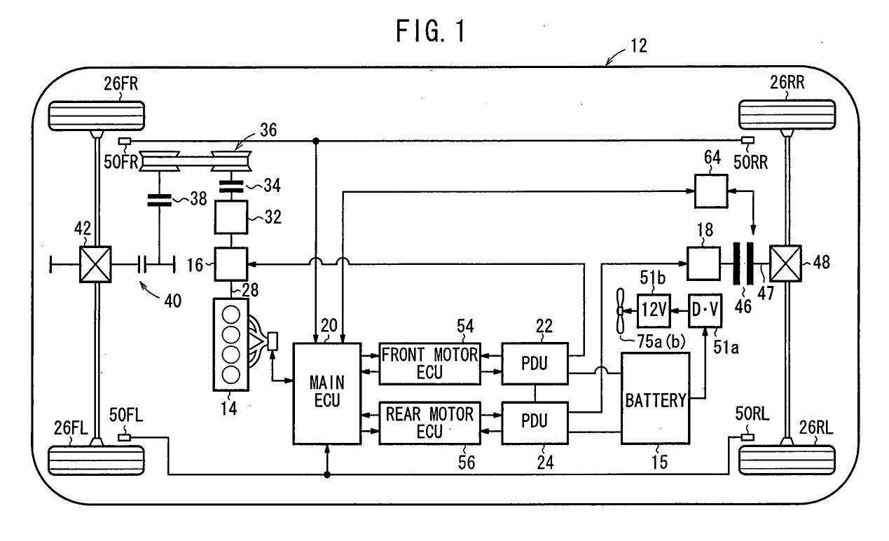

FIG. 1 shows in block form a hybrid vehicle 12 including a control apparatus for a hybrid vehicle according to the present invention.

As shown in FIG. 1, the hybrid vehicle 12 is a four-wheel-drive vehicle and has an internal combustion engine 14, a first motor 16 and a second motor 18 energizable by electric power supplied from a battery 15, and a main ECU (running state estimating unit, output changing unit, amount-of-generated-electric-power changing unit, Electronic Control Unit) 20 for centralized management and control of the engine 14, the first motor 16, the second motor 18, etc. The main ECU 20 comprises a microcomputer (not shown) made up of a RAM (Random Access Memory), a ROM (Read Only Memory), a CPU (Central Processing Unit), an input/output interface, a timer, and other components. The main ECU 20 performs its processing operation according to programs, maps, data, etc. that are stored in the ROM. The main ECU 20 can operate in various different manners based on program changes or modifications.

The hybrid vehicle 12 also has a first PDU (Power Drive Unit) 22 for controlling electric power supplied to the first motor 16, a second PDU 24 for controlling electric power supplied to the second motor 18, two front wheels 26FL, 26FL that can be driven by the engine 14 and the first motor 16, and two rear wheels 26RL, 26RR that can be driven by the second motor 18.

The engine 14 and the first motor 16 are connected to a common drive shaft 28 and drive the front wheels 26FL, 26FR through an oil pump 32, a first clutch 34, a belt-and-pulley mechanism 36, a second clutch 38, a gear mechanism 40, and a first differential gear 42. The second motor 18 drives the rear wheels 26RL, 26RR through a third clutch 46, a drive shaft 47, and a second differential gear 48.

The first motor 16 and the second motor 18 also operate as generators under the control of the first PDU 22 and the second PDU 24. Specifically, the first motor 16 can be rotated by drive power supplied from the engine 14 or the front wheels 26FL, 26FR to generate electric power, which is stored in the battery 15. The second motor 18 can be rotated by drive power supplied from the rear wheels 26RL, 26RR to regenerate electric power, which is stored in the battery 15.

The front wheels 26FL, 26FR and the rear wheels 26RL, 26RR are associated with respective vehicle speed sensors 50FL, 50FR, 50RL, 50RR which are connected to the main ECU 20.

The voltage across the battery 15 is dropped by a downverter (D•V) 51a to a voltage of 12 V that is supplied through a 12V power supply controller 51b to fans (cooling devices) 75a, 75b.

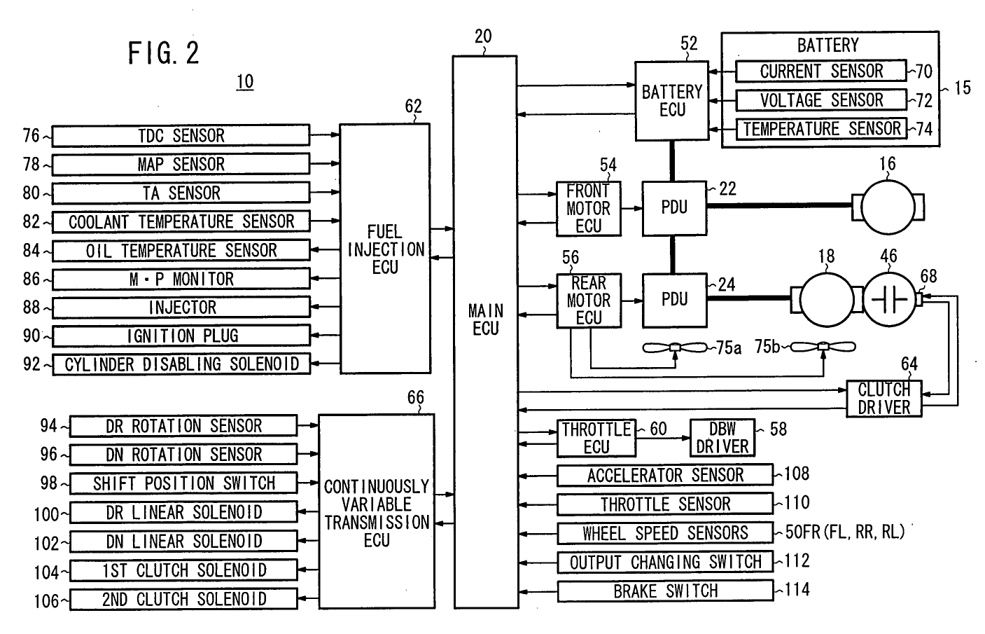

FIG. 2 shows in block form the control apparatus 10 for the hybrid vehicle 12. As shown in FIG. 2, the control apparatus 10 includes the main ECU 20, and has a battery ECU (state of charge detector) 52 for controlling the battery 15, a front motor ECU 54 for controlling the first motor 16 through the first PDU 22, a rear motor ECU 56 for controlling the second motor 18 through the second PDU 24, a throttle ECU 60 for controlling a throttle valve opening of the engine 14 through a DBW (Drive By Wire) driver 58, a fuel injection ECU 62 for controlling an injected amount of fuel, a clutch driver 64 for engaging and disengaging the third clutch 46, and a continuously variable transmission ECU 66 for controlling the belt-and-pulley mechanism 36. A clutch switch 68 for detecting when the third clutch 46 is engaged and disengaged is mounted on the third clutch 46, and is connected to the clutch driver 64.

The battery ECU 52 is connected to three sensors associated with the battery 15, i.e., a current sensor 70, a voltage sensor 72, and a temperature sensor 74. The current sensor 70 measures a current that flows to charge and discharge the battery 15. The voltage sensor 72 measures a voltage of the cell chamber of the battery 15. The temperature sensor 74 measures a temperature of the battery 15.

The battery ECU 52 has a function to calculate state of charge SOC of the battery 15 based on the voltage of the battery 15 or an integrated value of electrical energy charged in and discharged from the battery 15.

The fans 75a, 75b are positioned respectively near the second motor 18 and the second PDU 24. The fans 75a, 75b are rotated by the rear motor ECU 56 when a predetermined operation permission temperature or higher is reached.

To the fuel injection ECU 62, there are connected a TDC (Top Dead Center) sensor 76 for detecting a camshaft rotational angle, a MAP sensor 78 for detecting an intake air pressure, a TA (Temperature of Air) sensor 80 for detecting an intake air temperature, a coolant temperature sensor 82 for detecting an engine coolant temperature, an oil temperature sensor 84 for detecting an engine oil temperature, and an M•P (Master Power) monitor 86 for detecting a brake master power negative pressure. To the fuel injection ECU 62, there are also connected an injector 88 serving as a fuel injection actuator for each of the cylinders of the engine 14, an ignition plug 90 serving as a fuel ignition actuator for each of the cylinders of the engine 14, and a cylinder disabling solenoid 92 for selectively disabling cylinders of the engine 14.

To the continuously variable transmission ECU 66, there are connected a DR rotation sensor 94 for detecting a drive pulley rotational speed of the belt-and-pulley mechanism 36, a DN rotation sensor 96 for detecting a driven pulley rotational speed of the belt-and-pulley mechanism 36, and a shift position switch 98 for detecting a shift lever position. To the continuously variable transmission ECU 66, there are also connected a DR linear solenoid 100 for positioning a drive pulley of the belt-and-pulley mechanism 36, a DN linear solenoid 102 for positioning a driven pulley of the belt-and-pulley mechanism 36, a first clutch solenoid 104 for engaging and disengaging the first clutch 34, and a second clutch solenoid 106 for engaging and disengaging the second clutch 38.

To the main ECU 20, there are connected an accelerator sensor 108 for detecting the displacement AP of the accelerator pedal of the hybrid vehicle 12, a throttle sensor 110 for detecting a throttle valve opening, the vehicle speed sensors 50FL, 50FR, 50RL, 50RR, an output changing switch (output changing controller) 112 for changing the output of the second motor 18 based on a manual control action of the driver of the hybrid vehicle 12, and a brake switch 114 for detecting when the brake system of the hybrid vehicle 12 is turned on and off.

A control process of controlling operation of the hybrid vehicle 12 thus constructed will be described below. The control process is performed when the main ECU 20 executes programs stored in the ROM.

For example, when the hybrid vehicle 12 travels under a low load to keep a stable running speed, the main ECU 20 controls the clutch driver 64 to disengage the third clutch 46 to disconnect the second motor 18 and the differential gear 48 from each other. Then, the main ECU 20 drives the engine 14 to cause the first motor 16 to function as a generator, charging the battery 15 while the hybrid vehicle 12 is running. As any undue dragging loss during de-energization of the second motor 18 is reduced, the hybrid vehicle 12 can run with increased fuel economy.

When the hybrid vehicle 12 travels under a high load with sufficient drive power such as when the hybrid vehicle 12 runs uphill or on a snowy road, the main ECU 20 engages the third clutch 46 to connect the second motor 18 and the differential gear 48 to each other. The hybrid vehicle 12 now operates in a 4WD mode in which the engine 14 and the second motor 18 are simultaneously driven.

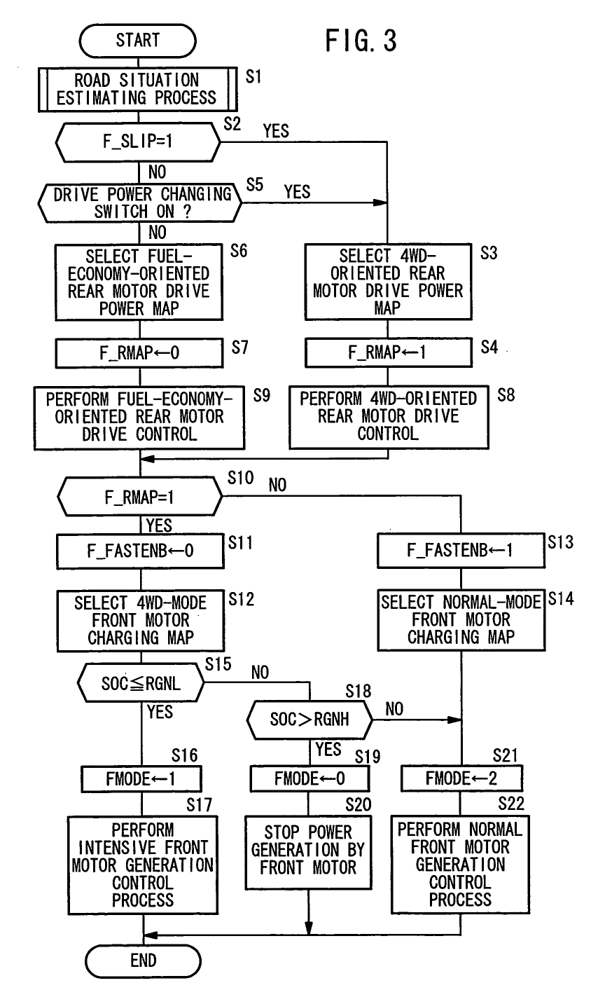

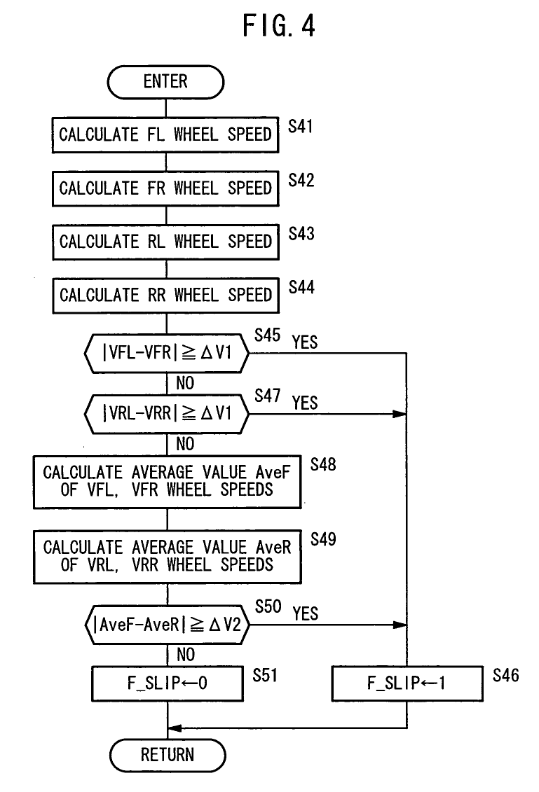

The control process in the 4WD mode will be described below with reference to flow charts of FIGS. 3 and 4.

First, the main ECU 20 performs a process of estimating a road situation indicative of a running state of the hybrid vehicle in step S1 shown in FIG. 3.

The road situation estimating process in step S1 will be described in detail below with reference to FIG. 4.

The main ECU 20 counts the number of pulses per unit time of pulse signals output from the respective vehicle speed sensors 50FL, 50FR, 50RL, 50RR for thereby calculating respective wheel speeds VFL, VFR, VRL, VRR of the front wheels 26FL, 26FR and the rear wheels 26RL, 26RR in steps S41, S42, S43, S44.

Then, the main ECU 20 compares the speed difference |VFL−VFR| between the wheel speeds VFL, VFR of the front wheels 26FL, 26FR with a predetermined slip decision value V1 in step S45. If |VFL−VFR|≧ΔV1, then the main ECU 20 judges that one of the front wheels 26FL, 26FR is slipping with respect to the other, and sets a wheel slip flag F_SLIP to “1” in step S46. The main ECU 20 also compares the speed difference |VRL−VRR| between the wheel speeds VRL, VRR of the rear wheels 26RL, 26RR with the slip decision value V1 in step S47. If |VRL−VRR|≧ΔV1, then the main ECU 20 judges that one of the rear wheels 26RL, 26RR is slipping with respect to the other, and sets the wheel slip flag F_SLIP to “1” in step S46.

If both the speed difference |VFL−VFR| between the front wheels 26FL, 26FR and the speed difference |VRL−VRR| between the rear wheels 26RL, 26RR are smaller than the slip decision value ΔV1, then the main ECU 20 calculates an average value AveF=(VFL+VFR)/2 of the wheel speeds VFL, VFR of the front wheels 26FL, 26FR in step S48 and calculates an average value AveR=(VRL+VRR)/2 of the wheel speeds VRL, VRR of the rear wheels 26RL, 26RR in step S49. Then, the main ECU 20 compares the speed difference |AveF−AveR| between the average values AveF, AveR with a slip decision value ΔV2 in step S50. If |AveF−AveR|≧ΔV2, then the main ECU 20 judges that either the front wheels 26FL, 26FR or the rear wheels 26RL, 26RR is slipping with respect to the other, and sets the wheel slip flag F_SLIP to “1” in step S46.

If the speed differences |VFL−VFR|, |VRL−VRR| are smaller than the slip decision value ΔV1 in steps S45, S47, and the speed difference |AveF−AveR| is smaller than the slip decision value ΔV2 in step S50, then the main ECU 20 judges that the wheels are not slipping, and sets the wheel slip flag F_SLIP to “0” in step S51. After step S46 or S51, control goes back to the main routine shown in FIG. 3.

The main ECU 20 confirms the value of the wheel slip flag F_SLIP in step S2 shown in FIG. 3. If the wheel slip flag F_SLIP is “1”, then since a wheel or wheels are judged as slipping, the main ECU 20 selects a 4WD-oriented rear motor drive power map, described later, for increasing the output of the second motor 18 to avoid the wheel slip in step S3. Then, the main ECU 20 sets a 4WD-oriented rear motor drive power map selection flag F_RMAP to “1” in step S4.

The hybrid vehicle 12 has the output changing switch 112 which can be operated by the driver of the hybrid vehicle 12 to manually select the 4WD-oriented rear motor drive power map irrespective of whether the wheel slip flag F_SLIP is set or not. Therefore, when the driver judges from the running state of the hybrid vehicle 12 that the output power is not enough, the driver can turn on the output changing switch 112 in step S5, thus selecting the 4WD-oriented rear motor drive power map in step S3.

If the wheel slip flag F_SLIP is “0” in step S2, then the main ECU 20 judges that the front wheels 26FL, 26FR and the rear wheels 26RL, 26RR are not slipping. Thereafter, if the driver does not turn on the output changing switch 112 in step S5, then the ECU 20 selects a fuel-economy-oriented rear motor drive power map, described later, for increasing fuel economy in step S6. Then, the main ECU 20 sets the 4WD-oriented rear motor drive power map selection flag F_RMAP to “0” in step S7.

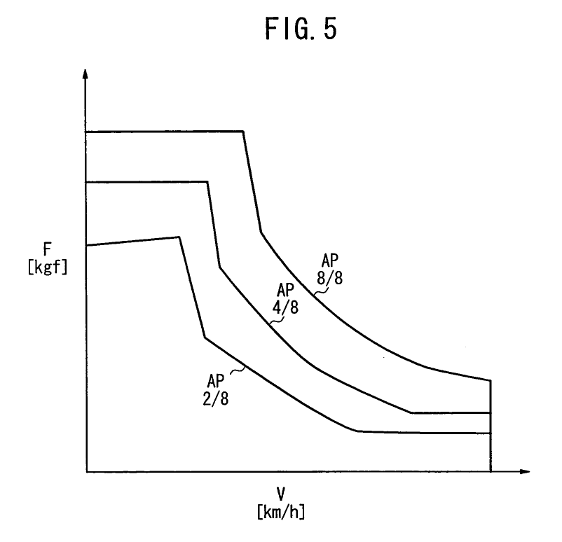

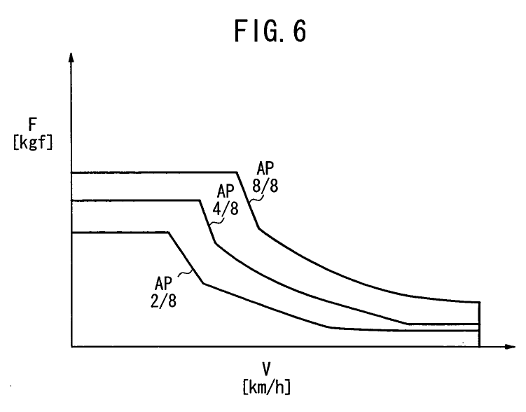

FIG. 5 shows the 4WD-oriented rear motor drive power map which is stored in the ROM of the main ECU 20. FIG. 6 shows the fuel-economy-oriented rear motor drive power map which is stored in the ROM of the main ECU 20. Each of the 4WD-oriented rear motor drive power map and the fuel-economy-oriented rear motor drive power map contains various values of the drive power F (kgf) which the second motor 18 is required to produce at various values of the vehicle speed V (km/h) of the hybrid vehicle 12 for different values of the displacement AP of the accelerator pedal. In FIG. 5, the curves AP2/8, AP4/8, AP8/8 represent the ratios 2/8, 4/8, 8/8 of the displacement AP of the accelerator pedal. Therefore, as the displacement AP of the accelerator pedal is larger, the drive power F produced by the second motor 18 (the rear motor) becomes greater.

If the 4WD-oriented rear motor drive power map is selected in step S3, then the rear motor ECU 56 energizes the second motor 18 to produce the drive power F shown in FIG. 5 with the electric power that is supplied from the battery ECU 52 through the second PDU 24 in step S8. Since the rear wheels 26RL, 26RR of the hybrid vehicle 12 are driven by the sufficiently large drive power F based on the 4WD-oriented rear motor drive power map, the hybrid vehicle 12 can run stably without undue wheel slip.

If the fuel-economy-oriented rear motor drive power map is selected in step S6, then the rear motor ECU 56 energizes the second motor 18 to produce the normal drive power F shown in FIG. 6 with the electric power that is supplied from the battery ECU 52 through the second PDU 24 in step S9. Since the drive power F which the second motor 18 is required to produce is smaller than if a wheel slip is detected, the electric power consumed from the battery 15 by the second motor 18 is relatively small. Therefore, the engine 14 does not need to be operated excessively to charge the battery 15, and hence the hybrid vehicle 12 can run with reasonable fuel economy.

Then, the main ECU 20 confirms the 4WD-oriented rear motor drive power map selection flag F_RMAP that has been set in step S4 or S7 in step S10. If the 4WD-oriented rear motor drive power map selection flag F_RMAP is “1”, then since the electric power stored in the battery 15 is consumed at a high rate for energizing the second motor 18, the main ECU 20 sets a front-assist permission flag F_FASTENB to “0” in step S11, prohibiting the first motor 16 from assisting the engine 14. The main ECU 20 then selects a 4WD-mode front motor charging map for positively charging the battery 15 with the first motor 16 in step S12.

If the 4WD-oriented rear motor drive power map selection flag F_RMAP is “0” in step S10, then the main ECU 20 judges that the electric power consumed by the second motor 18 is small, and sets the front-assist permission flag F_FASTENB to “1” in step S13. Thereafter, the main ECU 20 selects a normal-mode front motor charging map for normally charging the battery 15 with the first motor 16 in step S14.

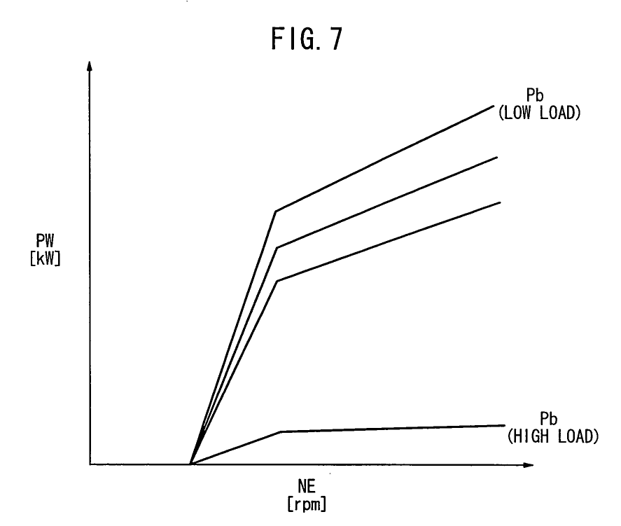

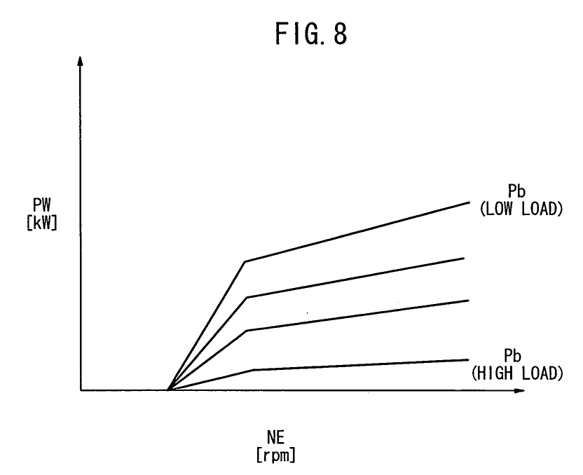

FIG. 7 shows the 4WD-mode front motor charging map that is stored in the ROM of the main ECU 20. FIG. 8 shows the normal-mode front motor charging map that is stored in the ROM of the main ECU 20. Each of the 4WD-mode front motor charging map and the normal-mode front motor charging map contains various values of the amount of generated electric power PW (kW) which the first motor 16 is required to generate at various values of the rotational speed NE (rpm) of the engine 14 for different values of the load Pb on the engine 14. The amount of generated electric power PW which the first motor 16 is required to generate is smaller as the load Pb on the engine 14 is greater, thus avoiding an undue loss, caused by the first motor 16, of the drive power of the engine 14 to prevent the drivability of the hybrid vehicle 12 from being lowered.

If the 4WD-mode front motor charging map is selected in step S12, then the battery ECU 52 calculates state of charge SOC of the battery 15 based on detected signals from the current sensor 70 and the voltage sensor 72, and compares the calculated state of charge SOC with a lower limit value RGNL for the electric power required to drive the hybrid vehicle 12 in the 4WD mode with the engine 14 and the second motor 18 in step S15.

If SOC≦RGNL, then the main ECU 20 sets a front generation mode flag FMODE to “1” in step S16, and performs an intensive front motor generation control process based on the 4WD-mode front motor charging map shown in FIG. 7 in step S17. At this time, the second motor 18 has been energized based on the 4WD-oriented rear motor drive power map shown in FIG. 5. The first motor 16 is driven to generate a large amount of electric power according to the 4WD-oriented rear motor drive power map in order to make up for the electric power consumed by the second motor 18.

If the state of charge SOC is equal to or smaller than a preset value which is further smaller than the lower limit value RGNL, then it is expected that the electric power required to energize the second motor 18 may not be provided by the first motor 16. In this case, it is preferable to limit the output of the second motor 18.

If SOC≧RGNL in step S15, then the main ECU 20 sets an upper limit value RGNH for the electric power which is obtained by subtracting a marginal amount of electric power generated by decelerated regeneration from the charged amount of electric power stored in the battery 15 as it is fully charged, and compares the upper limit value RGNH with the state of charge SOC in step S18.

If SOC≧RGNH, then since the state of charge SOC of the battery 15 is large enough to operate the hybrid vehicle 12 in the 4WD mode, the main ECU 20 sets the front generation mode flag FMODE to “0” in order to increase the fuel economy of the engine 14 in step S19, and thereafter stops power generation by the first motor 16 in step S20. The load imposed on the engine 14 on the first motor 16 is now reduced for increased fuel economy.

If RGNL<SOC≦RGNH, then the main ECU 20 sets the front generation mode flag FMODE to “2” in step S21, and performs a normal front motor generation control process based on the normal-mode front motor charging map shown in FIG. 8 in step S22. In the normal front motor generation control process, the first motor 16 is driven to generate electric power based on the normal-mode front motor charging map. Thus, the engine 14 provides reasonable fuel economy, and electric power is provided for energizing the second motor 18 based on the 4WD-oriented rear motor drive power map.

According to the above embodiment of the present invention, as described above, in the 4WD mode, the running state of the hybrid vehicle 12 is estimated and the output of the second motor 18 is controlled to propel the hybrid vehicle 12 in a slip-free stable state. When the output of the second motor 18 is increased, a large amount of electric power stored in the battery 15 is consumed. To make up for the consumed amount of electric power, the first motor 16 is driven to generate electric power for thereby continuously propelling the hybrid vehicle 12 with the required output. The first motor 16 for producing the required electric power is appropriately controlled depending on the driven state of the second motor 18 and the state of charge SOC of the battery 15. Therefore, the first motor 16 is prevented from generating excessive electric power, and hence poses a minimum load required on the engine 14 for reasonable fuel economy.

In the above embodiment, the power generation modes of the first motor 16 are switched according to the state of charge SOC of the battery 15. However, the power generation modes of the first motor 16 may be switched according to an average value of the output per unit time of the second motor 18 or a change per unit time in the state of charge SOC of the battery 15.

Although a certain preferred embodiment of the present invention has been shown and described in detail, it should be understood that various changes and modifications may be made therein without departing from the scope of the appended claims.

What is claimed is:

1. A control apparatus for controlling a hybrid vehicle having an engine for driving one of front and rear wheels, a first motor connected to said engine for driving one of said front and rear wheels and generating electric power, a second motor driving the other of said front and rear wheels and generating electric power, and a battery for storing electric power generated by said first motor and said second motor and supplying electric power to said first motor and said second motor, said control apparatus comprising:
a running state estimating unit for estimating a running state of the hybrid vehicle; and
an output changing unit for changing the output of said first motor and said second motor depending on said running state estimated by said running state estimating unit.

2. A control apparatus for controlling a hybrid vehicle having an engine for driving one of front and rear wheels, a first motor connected to said engine for driving one of said front and rear wheels and generating electric power, a second motor driving the other of said front and rear wheels and generating electric power, and a battery for storing electric power generated by said first motor and said second motor and supplying electric power to said first motor and said second motor, said control apparatus comprising:
an output changing controller for making a control action to change the output of said second motor; and
an output changing unit for changing the output of said second motor depending on the control action made by said output changing controller.

3. A control apparatus according to claim 1, wherein said output changing unit increases the output of said second motor when said running state estimating unit estimates said running state as a slipping state of one of said front and rear wheels.

4. A control apparatus according to claim 1, further comprising:
an amount-of-generated-electric-power changing unit for changing the amount of electric power generated by said first motor when the output of said second motor is changed by said output changing unit.

5. A control apparatus according to claim 2, further comprising:
an amount-of-generated-electric-power changing unit for changing the amount of electric power generated by said first motor when the output of said second motor is changed by said output changing unit.

6. A control apparatus according to claim 4, further comprising:
a state of charge detector for detecting state of charge of said battery;
wherein said amount-of-generated-electric-power changing unit changes the amount of electric power generated by said first motor based on said state of charge when said output changing unit increases the output of said second motor.

7. A control apparatus according to claim 5, further comprising:
a state of charge detector for detecting a state of charge of said battery;
wherein said amount-of-generated-electric-power changing unit changes the amount of electric power generated by said first motor based on said state of charge when said output changing unit increases the output of said second motor.

8. A control apparatus according to claim 6, wherein said amount-of-generated-electric-power changing unit increases the amount of electric power generated by said first motor if said state of charge is equal to or smaller than a predetermined amount, and stops power generation by said first motor or does not change the amount of electric power generated by said first motor if said state of charge is greater than said predetermined amount.

9. A control apparatus according to claim 7, wherein said amount-of-generated-electric-power changing unit increases the amount of electric power generated by said first motor if said state of charge is equal to or smaller than a predetermined amount, and stops power generation by said first motor or does not change the amount of electric power generated by said first motor if said state of charge is greater than said predetermined amount.
